(19) United States
(12) Patent Application Publication
(10) Pub. No.: US 2015/0012637 A1
(43) Pub. Date: Jan. 8, 2015

(54) MANAGEMENT CONTROL DEVICE, INFORMATION PROCESSING SYSTEM, AND METHOD FOR MANAGEMENT CONTROL

(71) Applicant: FUJITSU LIMITED, Kawasaki-shi (JP)

(72) Inventor: Michiyuki KATSUMATA, Kawasaki (JP)

(73) Assignee: Fujitsu Limited, Kawasaki (JP)

(21) Appl. No.: 14/494,120

(22) Filed: Sep. 23, 2014

Related U.S. Application Data
(63) Continuation of application No. PCT/JP2012/057984, filed on Mar. 27, 2012.

(51) Int. Cl. H04L 29/08; H04L 12/24

(52) U.S. Cl. CPC H04L 67/16; H04L 41/14
USPC 709/223

(57) ABSTRACT

A management card includes an information acquisition unit that acquires state-transition information transmitted from each of a plurality of information processing devices started up, depending on the state transition of the information processing device, the state-transition information indicating the current activation state of the information processing device, and a start-up processing unit that transmits, based on the acquisition of the state-transition information from a specific information processing device out of the information processing devices, an instruction of transition to the next state with respect to the specific information processing device in priority to an instruction other than the instruction of transition with respect to an information processing device other than the specific information processing device out of the information processing devices.

### CROSS-REFERENCE TO RELATED APPLICATION

This application is a continuation of International Application No. PCT/JP2012/057984, filed on Mar. 27, 2012, the entire contents of which are incorporated herein by reference.

### FIELD

The embodiment discussed herein is related to a management control device, an information processing system, and a method for management control.

### BACKGROUND

In recent years, the introduction of a blade server has been accelerated because of space savings by high density mounting, easy system extensiveness, or the like. A system using the blade server enables the unified management of a plurality of servers thus improving the operation manageability thereof. As one example of the unified management of servers, the blade servers may be concurrently started up.

On the other hand, the number of the blade server that conforms to the Advanced Telecom Computing Architecture (ATCA) standard has also been increased. The ATCA standard provides the physical and logical specifications of the computer for communication common carriers, and standardizes basic structures of a casing, a blade board (blade server, for example) housed in the casing, or the like. A system can be constructed by combining blade boards each of which has various kinds of functions and conforms to the ATCA standard. In the system that conforms to the ATCA standard, a blade board specified in the ATCA standard is added to the housing specified in the ATCA standard, or the blade board is replaced by another blade board that implements other functions thereon and is specified in the ATCA standard thus changing the functions of the system easily. Accordingly, the blade server that conforms to the ATCA standard is used thus facilitating the extension of the system.

When the blade server that conforms to the ATCA standard starts up, a management card that is a management control device and the blade server are communicated with each other and at the same time, the state of the blade server is changed in accordance with the sequence specified in the ATCA standard. The blade server and the management card are connected with each other via an Intelligent Platform Management Bus (IPMB), and a communication between the blade server and the management card is performed by the IPMB communication.

Here, the outline of starting up the blade server is explained. The blade server communicates with the management card via the IPMB thus starting up while changing a state thereof to each activation state specified in the ATCA standard.

First of all, the blade server assumes a power OFF state. In this state, to be more specific, power is supplied only to an Intelligent Platform Management Controller (IPMC) for communicating with the management card in a state that the blade server is mounted on a chassis. Hereinafter, this state is referred to as “state 1.”

State 1 of the blade server is changed to a state that the blade server is ready to initiate a start-up operation by an instruction from the management card, an operation of an electric power switch mounted on the blade server, or the like. Hereinafter, this state is referred to as “state 2.” The state of the blade server is changed to state 2 thus initiating the start-up operation.

State 2 of the blade server is changed, upon receiving the instruction of start permission from the management card, to a state that is ready to be changed to an operation state. Hereinafter, this state is referred to as “state 3.”

State 3 of the blade server is changed, upon receiving the instruction of operation permission from the management card, to the state of being an operation state that power is also supplied to parts other than the IPMC. Hereinafter, this state is referred to as “state 4.”

After being changed to state 4, the blade server notifies the management card of information for the state management of hardware, such as voltage or temperature, (referred to as “sensor information” in some cases) as information for operation management. The blade server notifies the management card of information that indicates functions of the blade server, or information such as a serial number or a production number (referred to as “production information” in some cases).

When the blade servers each of which conforms to the ATCA standard are concurrently started up, start-up processing is performed in accordance with the sequence illustrated in FIG. 12. FIG. 12 is a sequence diagram illustrating the conventional start-up processing of the blade server by the management card. FIG. 12 illustrates a case that three sets of blade servers #1 to #3 are concurrently started up, as an example. In each process illustrated in FIG. 12, the process indicated with a numeral #1, #2, or #3 performs processing with respect to the server to which the numeral is given.

Conventionally, the management card completes, as illustrated in FIG. 12, the start-up operation of one blade server and thereafter, performs the start-up operation of the next blade server. In this manner, the management card sequentially performs the start-up operation of the blade server. Accordingly, for example, in FIG. 12, the blade server #3 is continuously in a state of waiting start-up processing during a period including a sensor information acquisition period 901 and a production information acquisition period 902 of the blade server #1, and a sensor information acquisition period 903 and a production information acquisition period 904 of the blade server #2. Here, each length of the periods 901 to 904 may be, for example, a value obtained by multiplying 16 Bytes by several tens of cycles depending on the quantity of information to be collected.

Here, as a technique of transmitting and receiving data, there has been a conventional technique that determines the priority of a received packet to store a high priority packet in a storage unit different from a storage unit in which a usual packet is stored (see Japanese Laid-open Patent Publication No. 2009-211342). As a technique of managing a blade board, there has been a conventional technique that compares data of the database storing the information of a blade board with a part of data collected from each blade board and omits the extraction of duplicate data (see Japanese Laid-open Patent Publication No. 2011-60056).

However, when a plurality of blade servers each of which conforms to the AICA standard are concurrently started up as illustrated in FIG. 12, communication between the management card and the blade server becomes a high load state. When the communication is in a high load state, the state transition of the blade server in start-up operation may be delayed. In that case, there is a risk that the blade server detects timeout and fails in a start-up operation. For example, in FIG. 12, there is a risk that, at the time when the period 905 elapses, the blade server #3 may detect timeout and the start-up processing of the blade server #3 may finish.

Even when the conventional technique that stores a high priority packet in a storage unit different from a storage unit in which a usual packet is stored, or the conventional technique that omits the extraction of duplicate data is used, it is difficult to suppress the delay of the state transition in a start-up operation of a server.

### SUMMARY

According to an aspect of an embodiment, a management control device includes: an information acquisition unit that acquires state-transition information transmitted from each of a plurality of information processing devices started up, depending on state transition of each information processing device, the state-transition information indicating a current activation state of the information processing device; and a controller that transmits, based on the acquisition of the state-transition information from a specific information processing device out of the information processing devices, an instruction of transition to a next state with respect to the specific information processing device in priority to an instruction other than the instruction of transition with respect to an information processing device other than the specific information processing device out of the information processing devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an information processing system according to an embodiment;

FIG. 2 is a view illustrating a hardware configuration of a management card according to the embodiment;

FIG. 3 is a view illustrating a hardware configuration of a blade server according to the embodiment;

FIG. 4 is a block diagram of an IPMC in the management card according to the embodiment;

FIG. 5 is a view illustrating one example of a blade management table;

FIG. 6 is a view illustrating one example of an information collection state table;

FIG. 7 is a view illustrating one example of a blade number table;

FIG. 8A is a view illustrating one example of a reception message format;

FIG. 8B is a view illustrating one example of a transmission message format;

FIG. 8C is a view illustrating one example of a state-transition message format;

FIG. 9 is a flowchart of processing when the management card receives messages;

FIG. 10 is a flowchart illustrating the start-up processing of the blade server by the management card;

FIG. 11A is a sequence diagram illustrating the start-up processing of the blade server by the management card;

FIG. 11B is a sequence diagram illustrating the start-up processing of the blade server by the management card; and

FIG. 12 is a sequence diagram illustrating the conventional start-up processing of the blade server by the management card.

### DESCRIPTION OF EMBODIMENT

Preferred embodiments of the present invention will be explained with reference to accompanying drawings. Here, the management control device, the information processing system, and the method for management control that are disclosed in the present application are not limited to the embodiment described below.

### [a] Embodiment

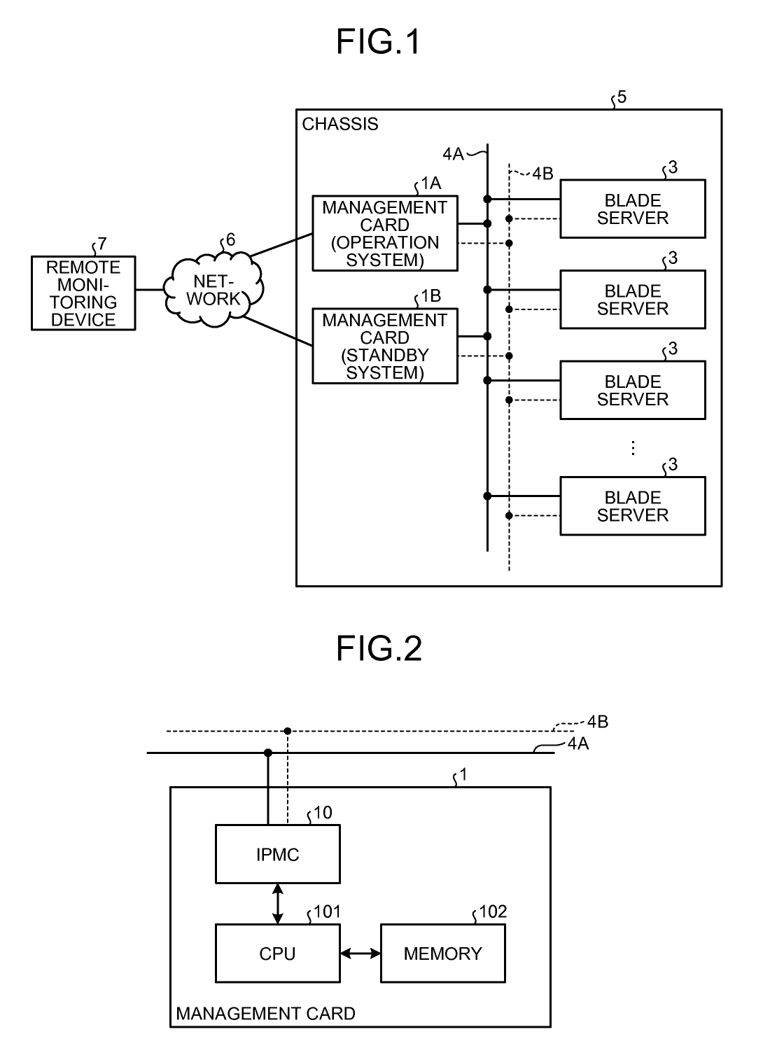

FIG. 1 is a block diagram of an information processing system according to an embodiment. As illustrated in FIG. 1, the information processing system according to the present embodiment has a management card 1A of an operation system, a management card 1B of a standby system, blade servers 3, a chassis 5, and a remote monitoring device 7. FIG. 1 illustrates four blade servers 3. However, the ATCA standard specifies that the number of the blade server is, for example, set to any number from 2 to 16. The chassis 5 is a housing that stores therein blade boards. The management cards 1A, 1B and the blade servers 3 are housed in the chassis 5. Each of the management cards 1A and 1B is one example of a “management control device.” The blade servers 3 are an example of an “information processing device.”

The management cards 1A, 1B and the remote monitoring device 7 are connected with each other via a network 6. The network 6 is the Internet, for example. The remote monitoring device 7 observes the operations or the like of the management cards 1A, 1B and the blade servers 3 via the network 6.

The management cards 1A, 1B and each blade server 3 are connected with each other via a duplexed bus constituted of IPMBs 4A and 4B. Hereinafter, when the IPMB 4A and the IPMB 4B do not have to be discriminated from each other, the IPMB 4A and the IPMB 4B are merely referred to collectively as “IPMB 4.”

The management card 1A manages the start-up operation of each blade server 3; that is, the management card 1A is a management control device with respect to each blade server 3. The management card 1A manages the operation of each blade server 3. The management card 1B takes over the processing that the management card 1A performs when a failure occurs in the management card 1A, for example. The management cards 1A and 1B are the operation system and the standby system, respectively, and the constitutions of the management cards 1A and 1B are identical with each other. Hence, in the explanation below, when the management card 1A and the management card 1B do not have to be discriminated from each other, the management card 1A and the management card 1B are merely referred to collectively as “management card 1.”

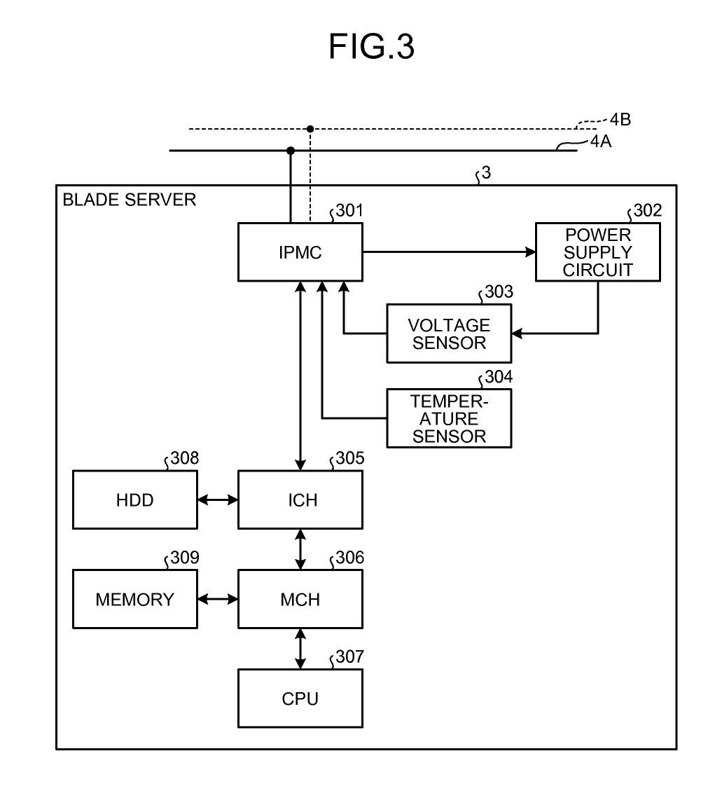

FIG. 2 is a view illustrating a hardware configuration of the management card. As illustrated in FIG. 2, the management card 1 has an IPMC 10, a central processing unit (CPU) 101, and a memory 102.

The IPMC 10 and the memory 102 are connected with the CPU 101 via a bus. The CPU 101 and the memory 102 execute and control various kinds of programs. For example, the CPU 101 and the memory 102 communicate with the remote monitoring device 7 in accordance with a protocol implemented therein. When a failure occurs, the CPU 101 and the memory 102 notify, for example, the remote monitoring device 7 of a trap in accordance with a simple network management protocol (SNMP).

The IPMC 10 controls communication with the blade servers 3 using the IPMB 4, the start-up processing of the blade server 3, or the like. The function of the IPMC 10 is explained in detail later.

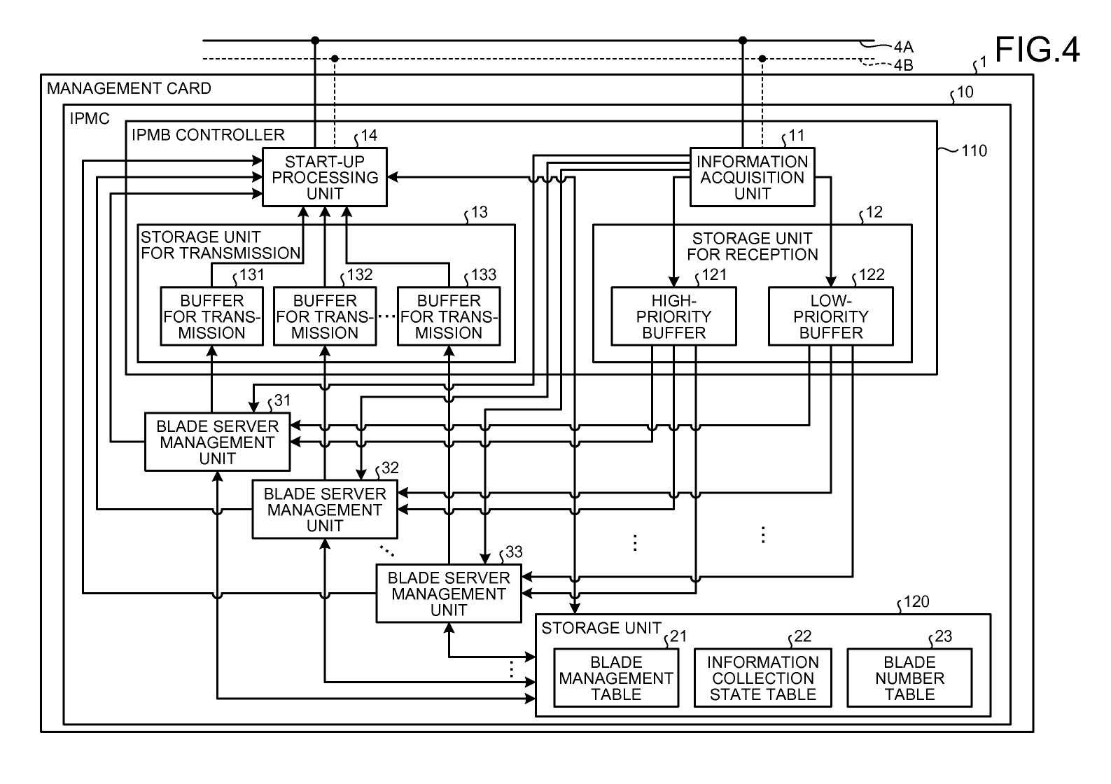

FIG. 3 is a view illustrating a hardware configuration of the blade server. The blade server 3 has an IPMC 301, a power supply circuit 302, a voltage sensor 303, a temperature sensor 304, an input output controller hub (ICH) 305, and a memory controller hub (MCH) 306. The blade server 3 has a CPU 307, a hard disk drive (HDD) 308, and a memory 309. In addition, in the present embodiment, the blade server 3 conforms to the ATCA standard.

The IPMC 301 controls, for example, communication with the management cards 1 using the IPMB 4.

The power supply circuit 302 is a circuit that supplies power to the blade server 3. The power supply circuit 302 receives a power-on instruction from the IPMC 301, and supplies power to the blade server 3.

The voltage sensor 303 measures a voltage supplied from the power supply circuit 302. The voltage sensor 303 transmits, upon receiving an instruction from the management card 1 in starting up the blade server 3, the measured value of the voltage to the management card 1 via the IPMC 301.

The temperature sensor 304 measures the temperature of the blade server 3. The temperature sensor 304 transmits, upon receiving an instruction from the management card 1 in starting up the blade server 3, the measured value of the temperature to the management card 1 via the IPMC 301.

The ICH 305 connects a channel from an I/O device such as the IPMC 301 or the HDD 308, and a channel to the CPU 307.

The MCH 306 connects a channel to the memory 309, a channel from the ICH 305, and a channel to the CPU 307.

The CPU 307 and the memory 309 execute, for example, various kinds of programs stored in the HDD 308. The CPU 307 and the memory 309 perform various kinds of processing in starting up the blade server 3.

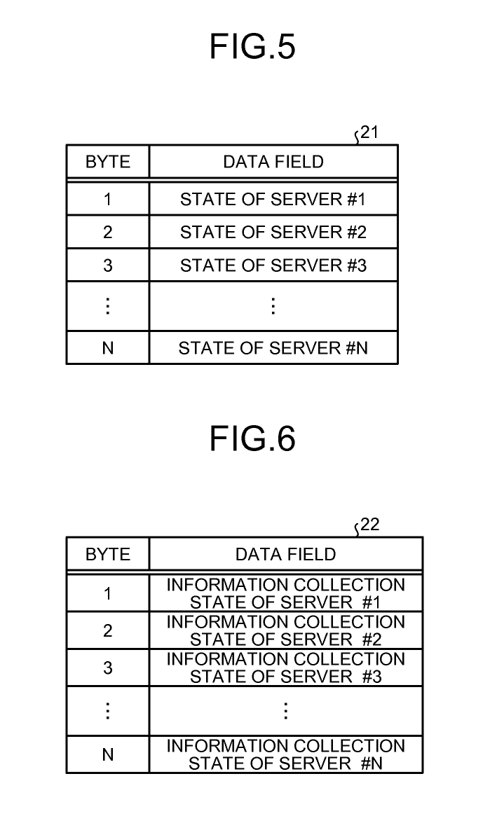

Next, with reference to FIG. 4, the function of the IPMC 10 in the management card 1 is explained. FIG. 4 is a block diagram of the IPMC in the management card. As illustrated in FIG. 4, the IPMC 10 of the management card 1 has an IPMB controller 110, a storage unit 120, and blade server management units 31 to 33. In FIG. 4, three blade server management units 31 to 33 are illustrated. However, there exist the same number of blade server management units as the number of the blade servers 3 to be managed. Here, the operation of each unit is explained in conjunction with state 1 to state 4 each of which is the activation state in a start-up operation of the blade server mentioned above. Here, state 2 is one example of a “first state.” State 3 is one example of a “second state.” In addition, state 4 is one example of a “third state.”

The IPMB controller 110 has an information acquisition unit 11, a storage unit for reception 12, a storage unit for transmission 13, and a start-up processing unit 14.

Each of the storage unit for reception 12 and the storage unit for transmission 13 is, for example, a cache memory, and stores data therein. The storage unit for reception 12 has a high-priority buffer 121, and a low-priority buffer 122. The storage unit for transmission 13 has buffers for transmission 131 to 133. Here, the buffers for transmission 131 to 133 exist so as to correspond to the blade server management units 31 to 33, respectively. That is, there exist the same number of buffers for transmission 131 to 133 as the number of the blade servers 3 so as to be in one to one relation therebetween. In the explanation below, when the blade server management units 31 to 33 do not have to be discriminated from each other, the blade server management units 31 to 33 are merely referred to collectively as a “blade server management unit 30.” When the buffers for transmission 131 to 133 do not have to be discriminated from each other, the buffers for transmission 131 to 133 are merely referred to collectively as a “buffer for transmission 130.” In addition, hereinafter, the explanation is made assuming that each of the blade server management unit 30, the buffer for transmission 130, and the blade server 3 communicates with the corresponding unit.

The storage unit 120 stores therein a blade management table 21, an information collection state table 22, and a blade number table 23.

The information acquisition unit 11 receives a message transmitted from the blade server 3 via the IPMB 4. The message includes start-up transition information that indicates the activation state of the blade server 3 in a start-up operation, blade type information that is determination information used for determining propriety of the transition to the next state, power information, or the like. A message including state-transition information is referred to as a “state-transition message” in some cases. Here, when the blade server 3 is in state 1, power is not supplied to the blade server 3 and not in an activatable state and hence, the state-transition information that indicates state 1 is not sent to the information acquisition unit 11. The message includes information for the state management of hardware, such as voltage or temperature, (hereinafter, referred to as “sensor information” in some cases). In addition, the message includes information that indicates the function of the blade server, information such as a serial number or a production number (hereinafter, referred to as “production information” in some cases). Hereinafter, the sensor information and the production information are referred to collectively as “operation information” in some cases.

The information acquisition unit 11 stores a start-up transition information message in the high-priority buffer 121 of the storage unit for reception 12. The information acquisition unit 11 also outputs determination information used for the transition of an activation state to the blade server management unit 30 corresponding to the blade server 3 that transmits the determination information. The information acquisition unit 11 also stores the sensor information, the production information, or the like in the low-priority buffer 122 of the storage unit for reception 12. The high-priority buffer 121 is one example of a “first storage unit.” The low-priority buffer 122 is one example of a “second storage unit.”

The blade server management unit 30 determines whether the start-up transition information is stored in the high-priority buffer 121. When the start-up transition information is stored in the high-priority buffer 121, the blade server management unit 30 corresponding to start-up transition information received with earlier timing acquires the start-up transition information.

The blade server management unit 30 requests, when the acquired start-up transition information indicates state 2, a blade type from the blade server 3 via the start-up processing unit 14. Here, the blade type is information for determining whether a blade server can be integrated into a system in accordance with the ATCA standard. The blade server management unit 30 receives the blade type transmitted from the blade server 3 from the information acquisition unit 11 as a response to the request of the blade type. The blade server management unit 30 determines whether the blade server 3 can be integrated into the system in accordance with the ATCA standard by using the received blade type. When the blade server 3 of a transmission source can be integrated into the system in accordance with the ATCA standard, the blade server management unit 30 transmits the instruction of start-up permission to the blade server 3 via the start-up processing unit 14.

The blade server management unit 30 also requests, when the acquired start-up transition information indicates state 3, power information from the blade server 3 via the start-up processing unit 14. Here, the power information is information that indicates the power consumption of the blade server 3. The blade server management unit 30 receives the power information transmitted from the corresponding blade server 3 as a response to the request of the power information from the information acquisition unit 11. The blade server management unit 30 determines whether the total power consumption of the blade boards incorporated in the chassis 5 exceeds an upper limit by using the received power information. When the power consumption does not exceed the upper limit, the blade server management unit 30 transmits the instruction of operation permission to the blade server 3 via the start-up processing unit 14.

The blade server management unit 30 registers, when the acquired start-up transition information indicates state 4, a fact that the state transition of the blade server 3 is completed in the blade management table 21. The blade server management unit 30 registers a fact that the acquisition of the state-transition information of the blade server 3 is completed in the information collection state table 22. The blade server management unit 30 stands by for communication with the management card for the start-up processing of the blade server 3 until the start-up transition information vanishes from the high-priority buffer 121. However, during this period, the blade server management unit 30 generates the command of a request for the sensor information or a request for the production information from the corresponding blade server 3, and stores the command in the corresponding buffer for transmission 130 in the state of a queue. To consider a case where the state transition of the blade server 3 is completed, when there exists no other blade server 3 that is in state 4, each of the blade server management units 31 to 33 registers the information of the blade server 3 in the blade number table 23. The buffer for transmission 130 is one example of an “instruction storage unit.”

On the other hand, when the start-up transition information is not stored in the high-priority buffer 121, the blade server 3 in state 4 is extracted from the blade management table 21. The blade server management unit 30 corresponding to the blade server 3 extracted instructs the start-up processing unit 14 to transmit the command stored in the buffer for transmission 130 to the corresponding blade server 3 in a round-robin manner in accordance with the queue of the command.

The start-up processing unit 14 receives the request for a blade type, the instruction of a start-up permission, the request for power information, and the instruction of operation permission from the blade server management unit 30. The start-up processing unit 14 transmits the received request for a blade type, the received instruction of a start-up permission, the received request for power information, and the received instruction of operation permission to the blade server 3 corresponding to the blade server management unit 30 that outputs the requests and the instructions.

The start-up processing unit 14 also receives the instruction of transmitting the command stored in the buffer for transmission 130 to the blade server 3 from the blade server management unit 30 corresponding to the blade server 3 that changes the state thereof to state 4. To be more specific, the start-up processing unit 14 is instructed to transmit the command stored in the buffer for transmission 130 in a round-robin manner in accordance with the queue of the command. The start-up processing unit 14 picks out each sensor information collection command from the buffer for transmission 130 in the queue order, and transmits each command one by one in a round-robin manner to the blade server 3 corresponding to the blade server management unit 30 from which the start-up processing unit 14 receives the instruction. As the specific method of transmitting commands in a round-robin manner, the start-up processing unit 14 sends, to a blade server 3 having identification information described in the blade number table 23, the sensor information collection command acquired from the buffer for transmission 130 corresponding to the blade server 3. The start-up processing unit 14 overwrites and registers the identification information of a blade server 3 next to the blade server 3 that transmits the sensor information collection command in the blade number table 23. Next, the start-up processing unit 14 sends, to a blade server 3 having the identification information described in the blade number table 23, the sensor information collection command acquired from the buffer for transmission 130 corresponding to the blade server 3. In this manner, the start-up processing unit 14 transmits a command to each blade server 3 in a round-robin manner.

To the last sensor information collection command stored in each buffer for transmission 130, information indicating that the command is the last sensor information collection command is added. The start-up processing unit 14 registers, whenever acquiring the last sensor information collection command from any of the buffers for transmission 130, information that indicates the completion of sensor information collection of the blade server 3 corresponding to the buffer for transmission 130 as an acquiring source in the information collection state table 22.

Subsequently, the start-up processing unit 14 continues to transmit, while acquiring production information collection commands from the buffer for transmission 130 from which the sensor information collection command vanishes, the production information collection commands in a round-robin manner. To the last production information collection command stored in each buffer for transmission 130, information indicating that the command is the last production information collection command is added. The start-up processing unit 14 registers, whenever acquiring the last production information collection command from any of the buffers for transmission 130, information that indicates the completion of production information collection of the blade server 3 corresponding to the buffer for transmission 130 that is an acquiring source in the information collection state table 22. Each of the start-up processing unit 14 and the blade server management unit 30 is one example of a “start-up controller”.

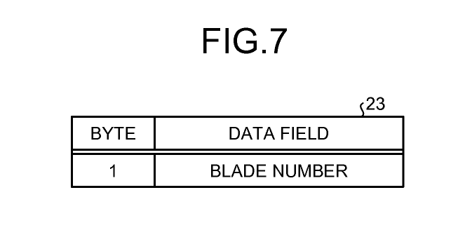

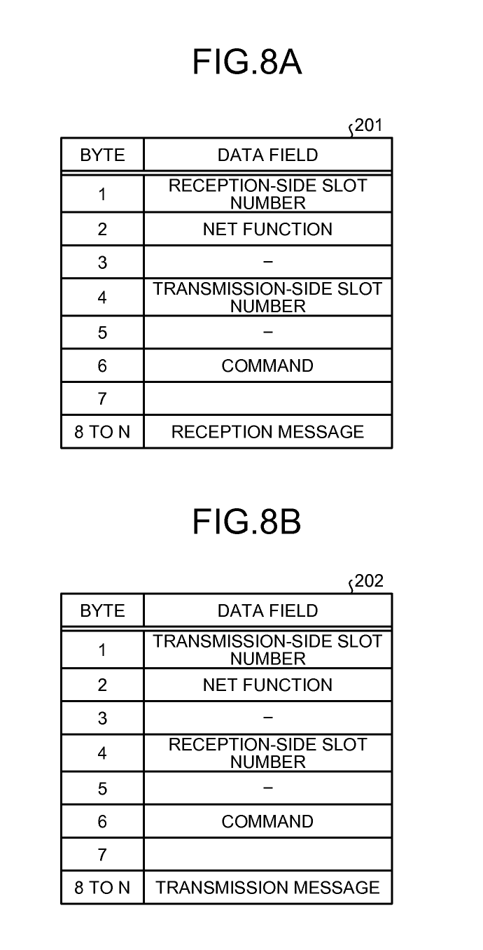

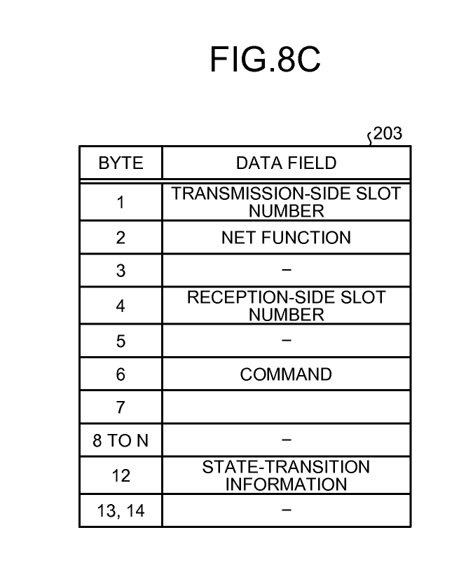

Here, with reference to FIG. 5, FIG. 6, and FIG. 7, one example with respect to each of the blade management table 21, the information collection state table 22, and the blade number table 23 is explained. FIG. 5 is a view illustrating one example of the blade management table. FIG. 6 is a view illustrating one example of the information collection state table. FIG. 7 is a view illustrating one example of the blade number table.

As illustrated in FIG. 5, the blade management table 21 stores the state of each blade server 3 therein for each byte. In the blade management table 21, when the corresponding blade server 3 is in state 4 that is a state that the transition of an activation state is completed, the state is indicated as 1 (one), and when the corresponding blade server 3 is in a previous activation state or a state that the collection of operation information is completed, or the corresponding blade server 3 does not exist, a state is indicated as 0 (zero). In FIG. 5, servers #1 to #N that are N sets of blade servers 3 are arranged, and the information on the state of the server #i is stored in the i-th byte (i=1 to N) of the blade management table 21. For example, when the activation state of a server #3 is in state 3, the third byte of the blade management table 21 is set to 0 (zero). When the activation state of the server #3 is changed to state 4, the blade server management unit 30 rewrites the third byte of the blade management table 21 as 1 (one).

As illustrated in FIG. 6, the information collection state table 22 stores the information collection state of each blade server 3 therein for each byte. In the information collection state table 22, when in collecting sensor information, an information collection state is denoted as 1 (one), and when in collecting production information, an information collection state is denoted as (two). In addition, when information collection is completed, or when the information collection is not performed, an information collection state is denoted as 3. For example, when the activation state of the server #3 is in state 3, the third byte of the information collection state table 22 is set to 0 (zero). When the activation state of the server #3 is changed to state 4, the blade server management unit 30 rewrites the third byte of the information collection state table 22 as 1 (one). Thereafter, when the collection of the sensor information of the server #3 is completed, the start-up processing unit 14 rewrites the third byte of the information collection state table 22 as 2 (two). In addition, when the collection of the production information of server #3 is completed, the start-up processing unit 14 rewrites the third byte of the information collection state table 22 as 0 (zero).

As illustrated in FIG. 7, the blade number table 23 stores therein the information of the blade server 3 subject to operation information collection in one byte. For example, a case is explained where identifiers 1 to N are respectively allocated to the servers #1 to #N that are N sets of blade servers 3. For example, when the server #3 is subject to operation information collection, the start-up processing unit 14 registers a value of 3 (three) in the blade number table 23. The start-up processing unit 14 collects the operation information of each blade server 3 in a round-robin manner and hence, for example, when the servers #1 to #N are concurrently started up, the start-up processing unit 14 collects the operation information while repeatedly rewriting the blade number table 23 in the order from 1 to N.

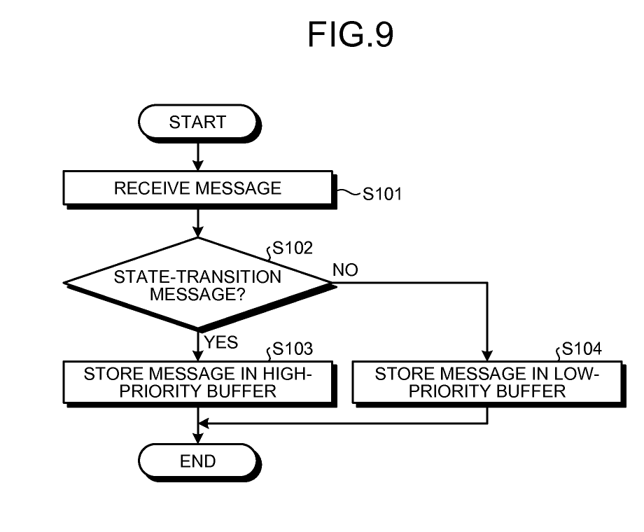

A specific method for transmission and reception of messages between the management card 1 and the blade server 3 is explained. FIG. 8A is a view illustrating one example of a reception message format. FIG. 8B is a view illustrating one example of a transmission message format. FIG. 8C is a view illustrating one example of a state-transition message format. FIG. 8A to FIG. 8C express the transmission message or the reception message as viewed from the blade server 3.

The blade server 3 receives the reception message having such a format 201 as illustrated in FIG. 8A from the management card 1. As illustrated in the format 201, Net function and Command are registered on a second byte and a sixth byte of the reception message register, respectively. Net function and Command include information that indicates what is requested. The blade server 3 acquires, from Net function and Command of reception message, a fact that what kind of information is included in the transmission message. For example, the blade server 3 refers to Net function and Command thus receiving the instruction of sensor information collection, the instruction of production information collection, or the like.

The blade server 3 sends a transmission message having such a format 202 as illustrated in FIG. 8B to the management card 1 as a response to the reception message. In the transmission message also, Net function and Command include information for identifying the contents of information. The management card 1 refers to Net function and Command that are stored in the reception message thus holding the result of sensor information collection or production information collection.

When notifying the management card 1 of state-transition information, the blade server 3 sends a state-transition message having such a format 203 as illustrated in FIG. 8C to the management card 1. The management card 1 refers to Net function and Command that are stored in the state-transition message to hold the fact that it is the state-transition message. Thereafter, the management card 1 refers to state-transition information registered on a twelfth byte of the state-transition message to acquire the activation state of the blade server that has sent the state-transition message.

Communication between the management card 1 and the blade server 3 is established with the use of a transmission message and a reception message that are paired. However, in the explanation made hereinafter, for the sake of convenience, the communication between the management card 1 and the blade server 3 may be explained without using one of the messages in some cases.

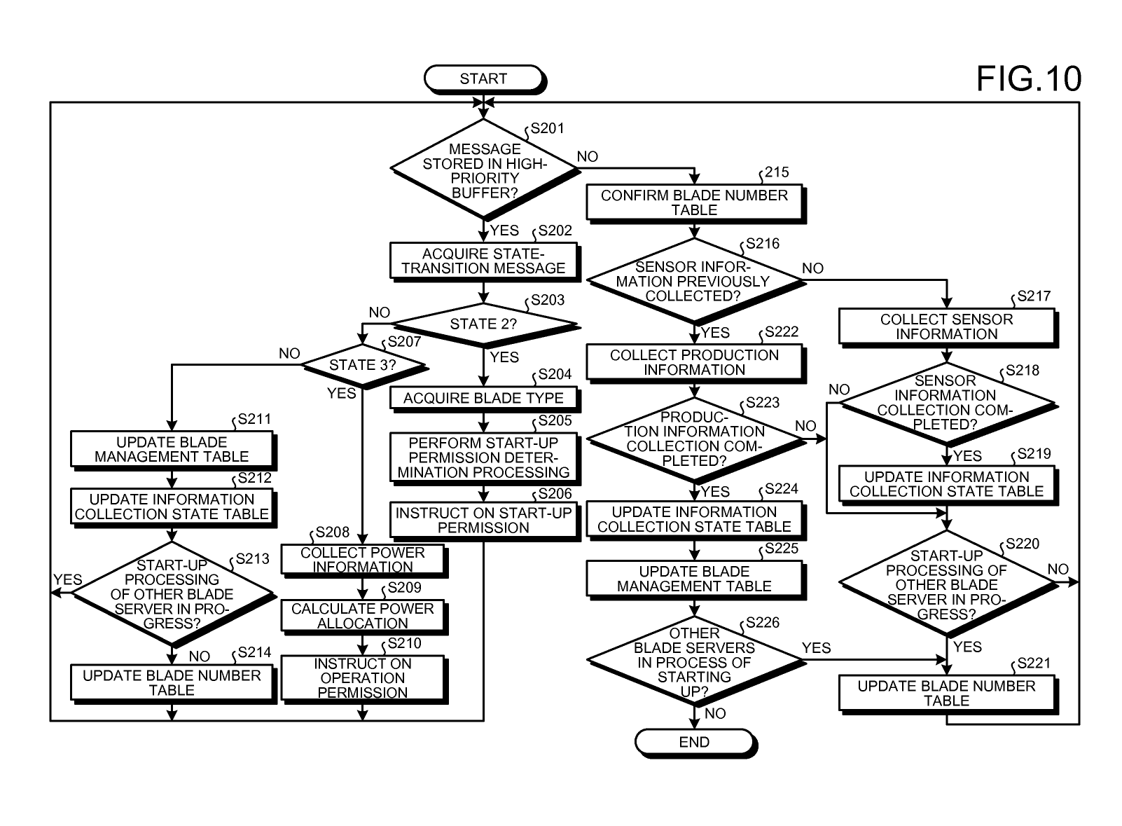

Next, with reference to FIG. 9, processing when a message is received in the management card 1 is explained. FIG. 9 is a flowchart of processing when the management card receives messages. Determination information acquired for determining the propriety of transition to the next state after receiving state-transition information is directly sent to a blade managing server by the information acquisition unit 11 and hence, the explanation of the determination information is omitted.

The information acquisition unit 11 receives a message from the blade server 3 (step S101). The information acquisition unit 11 determines whether the received message is a state-transition message that is a message including state-transition information (step S102).

When the received message is the state-transition message (Yes at step S102), the information acquisition unit 11 stores the received message in the high-priority buffer 121 (step S103). On the other hand, when the received message is not the state-transition message (No at step S102), the information acquisition unit 11 stores the received message in the low-priority buffer 122 (step S104).

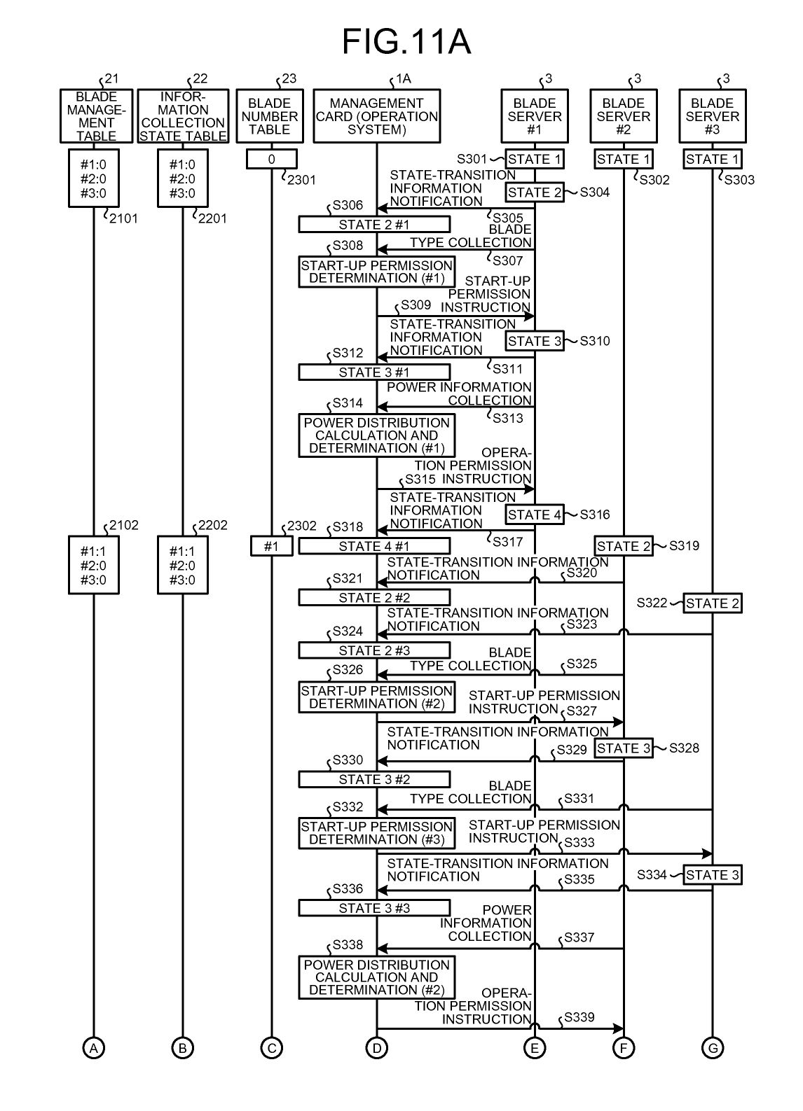

Next, with reference to FIG. 10, the explanation is made with respect to the processing of starting up the blade server 3 by the management card 1. FIG. 10 is a flowchart illustrating the start-up processing of the blade server by the management card.

The blade server management unit 30 determines whether the high-priority buffer 121 stores a message therein (step S201).

When the high-priority buffer 121 stores a message therein (Yes at step S201), the blade server management unit 30 acquires a state-transition message (step S202).

The blade server management unit 30 determines whether the state-transition information included in the acquired state-transition message indicates state 2 (step S203). When the state-transition information indicates state 2 (Yes at step S203), the blade server management unit 30 acquires a blade type from the blade server 3 (step S204). The blade server management unit 30 performs start-up permission determination processing that confirms from the blade type that the blade server 3 has a blade that can be integrated into a system in accordance with the ATCA standard (step S205).

In addition, the blade server management unit 30 instructs the blade server 3 on the start-up permission (step S206).

On the other hand, when the state-transition information does not indicate state 2 (No at step S203), the blade server management unit 30 determines whether the state-transition information included in the acquired state-transition message indicates state 3 (step S207). When the state-transition information indicates state 3 (Yes at step S207), the blade server management unit 30 collects power information from the blade server 3 (step S208). The blade server management unit 30 performs power allocation calculations, and confirms the continuation of the start-up processing with respect to the blade server 3 (step S209). In addition, the blade server management unit 30 instructs the blade server 3 on the operation permission (step S210).

On the other hand, when the state transition information does not indicate state 3 (No at step S207), the activation state of the blade server 3 is in state 4 and hence, the blade server management unit 30 registers information that indicates state 4 on the column of the corresponding server in the blade management table 21 to update the blade management table 21 (step S211). The blade management table 21 registers information that indicates a sensor information collection state on the column of the corresponding server in the information collection state table 22 to update the information collection state table 22 (step S212). The blade server management unit 30 determines whether the start-up processing of other blade server 3 is in progress (step S213). When the start-up processing of other blade servers 3 is in progress (Yes at step S213), the blade server management unit 30 returns the processing to step S201. On the other hand, when the start-up processing of other blade servers 3 is not in progress (No at step S213), the blade server management unit 30 rewrites the data stored in the blade number table 23 as the identification information of the corresponding blade server 3 and updates the blade number table 23 (step S214).

On the other hand, when the high-priority buffer 121 has no message (No at step S201), the start-up processing unit 14 confirms the blade number table 23 (step S215). Accordingly, the start-up processing unit 14 can specify a server that is set as a subject from which the operation information is to be acquired.

The start-up processing unit 14 determines whether the sensor information of the blade server 3 that has an identifier registered in the blade number table 23 has previously been collected (Step S216). When the sensor information has not previously been collected (No at step S216), the start-up processing unit 14 transmits the command acquired from the buffer for transmission 130 corresponding to the corresponding blade server 3, and collects the sensor information from the corresponding blade server 3 (Step S217). The start-up processing unit 14 determines whether the sensor information collection of the corresponding blade server 3 is completed depending on whether information indicating that the command is the last sensor information collection command is added to the acquired command (Step S218). When the sensor information collection is not completed (No at step S218), the start-up processing unit 14 advances the processing to step S220. On the other hand, when the sensor information collection is completed (Yes at step S218), the start-up processing unit 14 registers information indicating that production information collection is in progress on the column of the corresponding blade server 3 in the information collection state table 22 to update the information collection state table 22 (step S219). The start-up processing unit 14 determines whether other blade servers 3 are in start-up processing (step S220). When there is no other blade server 3 the start-up processing of which is in progress (No at step S220), the processing is returned to step S201. On the other hand, when there is such other blade server 3 the start-up processing of which is in progress (Yes at step S220), the start-up processing unit 14 rewrites the information of the blade number table 23 as the identification information of the next blade server 3 that is a subject from which the operation information is to be collected to update the blade number table 23 (step S221).

On the other hand, when the sensor information has previously been collected (Yes at step S216), the start-up processing unit 14 transmits a command acquired from the buffer for transmission 130 corresponding to the corresponding blade server 3, and collects production information from the corresponding blade server 3 (step S222). The start-up processing unit 14 determines whether the production information collection of the corresponding blade server 3 is completed depending on whether information indicating that the command is the last production information collection command is added to the acquired command (step S223). When the production information collection is not completed (No at step S223), the start-up processing unit 14 advances the processing to step S220. On the other hand, when the production information collection is completed (Yes at step S223), the start-up processing unit 14 registers information indicating that the operation information collection is completed on the column of corresponding blade server 3 in the information collection state table 22 to update the information collection state table 22 (step S224). The start-up processing unit 14 registers information that indicates start-up completion on the column of the corresponding blade server 3 in the blade management table 21 to update the blade management table 21 (step S225). The start-up processing unit 14 determines whether other blade servers 3 are in process of starting up (step S226). When there are other blade servers 3 that are in process of starting up (Yes at step S226), the start-up processing unit 14 advances the processing to step S221. On the other hand, when there is no other blade server 3 that is in process of starting up (No at step S226), the management card 1 finishes the start-up processing of the blade server 3.

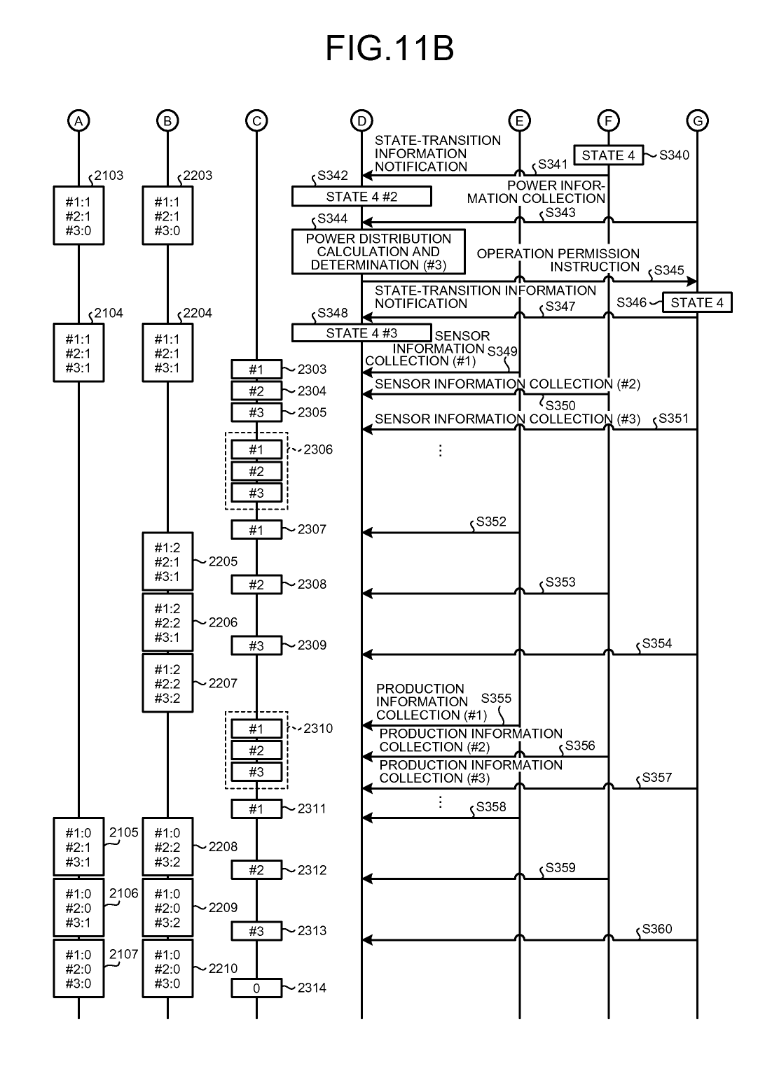

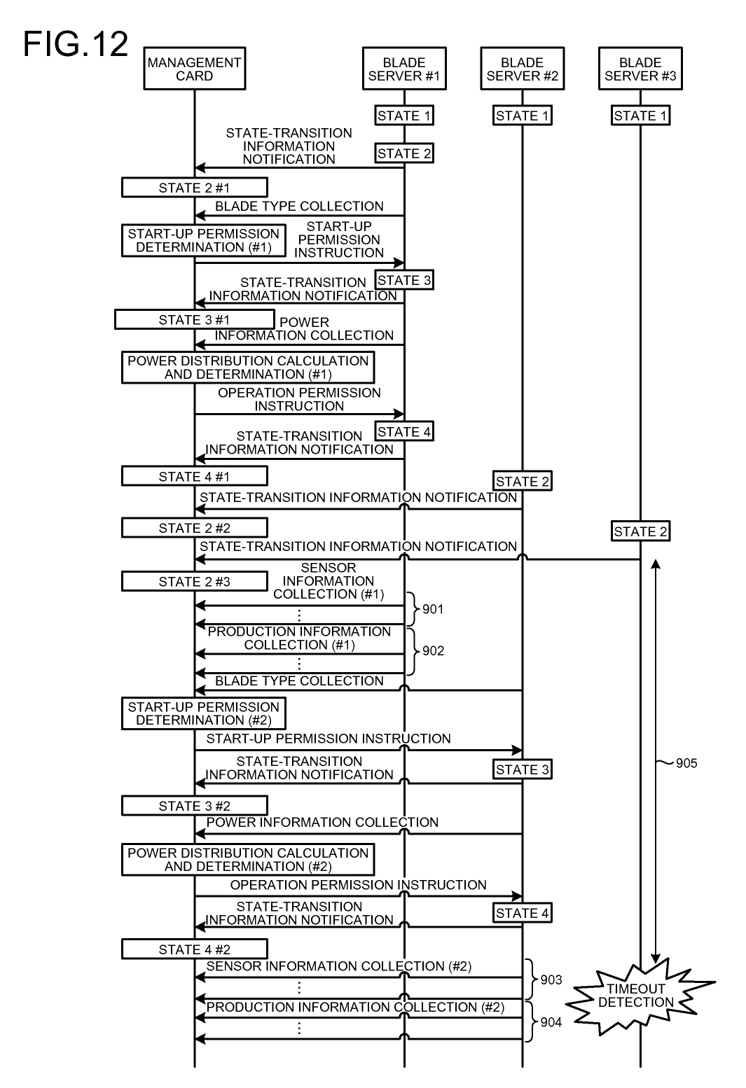

Next, with reference to FIG. 11A and FIG. 11B, the flow of the start-up processing of the blade server 3 by the management card 1 is further explained in detail. FIG. 11A and FIG. 11B are sequence diagrams each illustrating the start-up processing of a blade server by a management card. FIG. 11B is a continuation of FIG. 11A.

FIG. 11A and FIG. 11B illustrate the flow of processing when a management card 1A starts up three sets of blade servers 3. A line extending from the management card 1A or each blade server 3 indicates the passage of time, and each process described on the line is an operation performed by each unit corresponding to the line. An arrow that connects between the management card 1A and each blade server 3 indicates the data flow therebetween. Each of FIG. 11A and FIG. 11B illustrates the transition of registration contents of each table at the time corresponding to the sequence diagram in a juxtaposed manner to the sequence diagram. Here, in order to discriminate three servers, the explanation is made with respect to the individual servers referred to as a blade server #1, a blade server #2, and a blade server #3. Each process given numeral #1, #2, or #3 is performed with respect to the server having the same numeral. Here, the explanation is made in the case where the format of each table explained in conjunction with FIG. 5, 6, or 7 is used. In each table, in numeral #1, #2, or #3, information corresponding to the server having the numeral is described.

First of all, each of the blade servers #1 to #3 is not powered on and in the activation state of state 1 (steps S301 to S303). In this state, the blade management table 21 illustrates that, as illustrated in a table 2101, data of each of the blade servers #1 to #3 is set to 0 (zero), which indicates that each of the blade servers #1 to #3 is in an activation state prior to state 4. In the information collection state table 22, as illustrated in a table 2201, data of each of the blade servers #1 to #3 is set to 0 (zero), which indicates that each of the blade servers #1 to #3 does not collect operation information. In addition, in the blade number table 23, as illustrated in a table 2301, data is set to 0 (zero), which indicates that there is no server subject to operation information collection.

In this state, the blade server #1 is powered on and changes the state thereof into state 2 (step S304). Here, the blade server #1 notifies the management card 1A of the state-transition information thereof (step S305). Upon receiving the notification, the management card 1A acquires information that the activation state of the blade server #1 is the state 2 (step S306). Here, the management card 1A collects a blade type determination from the blade server #1 (step S307). The management card 1A determines the start-up permission of the blade server #1 depending on the collected blade type determination (step S308). The management card 1A notifies the blade server #1 of a start-up permission instruction (step S309).

Upon receiving the start-up permission instruction, the blade server #1 changes the activation state thereof into state 3 (step S310). The blade server #1 notifies the management card 1A of the state-transition information thereof (step S311). Upon receiving the state-transition information, the management card 1A acquires information that the activation state of the blade server #1 is state 3 (step S312). Here, the management card 1A collects power information from the blade server #1 (step S313). The management card 1A calculates and determines power distribution with respect to the blade server #1 depending on the collected power information (step S314). The management card 1A notifies the blade server #1 of an operation permission instruction (step S315).

Upon receiving the operation permission instruction, the blade server #1 changes the activation state thereof into state 4 (step S316). The blade server #1 notifies the management card 1A of the state-transition information thereof (step S317). Upon receiving the state-transition information, the management card 1A acquires information that the activation state of the blade server #1 is state 4 (step S318). Here, the management card 1A registers information indicating that the transition of the activation state is completed on the column of the blade server #1 in the blade management table 21. Accordingly, in the blade management table 21, as illustrated in a table 2102, data on the column of the blade server #1 is set to 1 (one). The management card 1A also registers information indicating that the sensor information collection is in progress on the column of the blade server #1 in the information collection state table 22. Accordingly, in the information collection state table 22, as illustrated in a table 2202, data on the column of the blade server #1 is set to 1 (one). The blade number table 23 is rewritten, as illustrated in a table 2302, so as to indicate the blade server #1.

At this timing, the blade server #2 is powered on and changes the activation state thereof into state 2 (step S319). Here, the blade server #2 notifies the management card 1A of the state-transition information thereof (step S320). Upon receiving the state-transition information, the management card 1A acquires information that the activation state of the blade server #2 is state 2 (step S321). At this timing, the blade server #3 is powered on and changes the activation state thereof into state 2 (step S322). Here, the blade server #3 notifies the management card 1A of the state-transition information thereof (step S323). Upon receiving the state-transition information, the management card 1A acquires information that the activation state of the blade server #3 is state 2 (step S324).

The management card 1A collects a blade type determination from the blade server #2 (step S325). The management card 1A determines the start-up permission of the blade server #2 depending on the collected blade type determination (step S326). The management card 1A notifies the blade server #2 of a start-up permission instruction (step S327).

Upon receiving the start-up permission instruction, the blade server #2 changes the activation state thereof into state 3 (step S328). The blade server #2 notifies the management card 1A of the state-transition information thereof (step S329). Upon receiving the state-transition information, the management card 1A acquires information that the activation state of the blade server #2 is state 3 (step S330).

Here, the high-priority buffer 121 has already stored therein a message indicating that the activation state of the blade server #3 is state 2 and hence, the management card 1A collects the blade type determination from the blade server #3 (step S331). The management card 1A determines the start-up permission of the blade server #3 depending on the collected blade type determination (step S332). The management card 1A notifies the blade server #3 of a start-up permission instruction (step S333).

Upon receiving the start-up permission instruction, the blade server #3 changes the activation state thereof into state 3 (step S334). The blade server #3 notifies the management card 1A of the state-transition information thereof (step S335). Upon receiving the state-transition information, the management card 1A acquires information that the activation state of the blade server #3 is state 3 (step S336).

Here, the high-priority buffer 121 has already stored therein a message indicating that the activation state of the blade server #2 is state 3 and hence, the management card 1A collects the power information from the blade server #2 (step S337). The management card 1A calculates and determines power distribution with respect to the blade server #2 depending on the collected power information (step S338). The management card 1A notifies the blade server #2 of an operation permission instruction (step S339).

Upon receiving the operation permission instruction, the blade server #2 changes the activation state thereof into state 4 (step S340). The blade server #2 notifies the management card 1A of the state-transition information thereof (step S341). Upon receiving the state-transition information, the management card 1A acquires information that the activation state of the blade server #2 is state 4 (step S342). Here, the management card 1A registers information indicating that the transition of the activation state is completed on the column of the blade server #2 in the blade management table 21. Accordingly, in the blade management table 21, as illustrated in a table 2103, data on each of the columns of the blade servers #1 and #2 is set to 1 (one). The management card 1A also registers information indicating that the sensor information collection is in progress on the column of the blade server #2 in the information collection state table 22. Accordingly, in the information collection state table 22, as illustrated in a table 2203, data on each of the columns of the blade servers #1 and #2 is set to 1 (one).

Next, the management card 1A collects the power information from the blade server #3 (step S343). The management card 1A calculates and determines power distribution with respect to the blade server #3 depending on the collected power information (step S344). The management card 1A notifies the blade server #3 of an operation permission instruction (step S345).

Upon receiving the operation permission instruction, the blade server #3 changes the activation state thereof into state 4 (step S346). The blade server #3 notifies the management card 1A of the state-transition information thereof (step S347). Upon receiving the state-transition information, the management card 1A acquires information such that the activation state of the blade server #3 is state 4 (step S348). Here, the management card 1A registers information indicating that the transition of the activation state is completed on the column of the blade server #3 in the blade management table 21. Accordingly, in the blade management table 21, as illustrated in a table 2104, data on each of the columns of the blade servers #1 to #3 is set to 1 (one). The management card 1A also registers information indicating that sensor information collection is in progress on the column of the blade server #3 in the information collection state table 22. Accordingly, in the information collection state table 22, as illustrated in a table 2204, data on each of the columns of the blade servers #1 to #3 is set to (one).

The management card 1A refers to the blade number table 23 to specify the blade server 3 subject to the operation information acquisition. At this timing, the blade number table 23 is in the state illustrated in a table 2303 and hence, the management card 1A sets the blade server #1 as a subject from which the operation information is to be acquired. The management card 1A collects sensor information from the blade server #1 (step S349). The blade number table 23 is rewritten, as illustrated in a table 2304, so as to indicate the blade server #2 that is a next subject from which the operation information is to be acquired.

The management card 1A refers to the blade number table 23 that is in the state illustrated in the table 2304 to set the blade server #2 as a subject from which the operation information is to be acquired. The management card 1A collects sensor information from the blade server #2 (step S350). The blade number table 23 is rewritten, as illustrated in a table 2305, so as to indicate the blade server #3 that is a next subject from which the operation information is to be acquired.

The management card 1A refers to the blade number table 23 that is in the state illustrated in the table 2305 to set the blade server #3 as a subject from which the operation information is to be acquired. The management card 1A collects sensor information from the blade server #3 (step S351).

Thereafter, the management card 1A repeatedly rewrites the blade number table 23 in the order from #1 to #3, as illustrated in a table group 2306. The management card 1A uses the blade number table 23 that is repeatedly rewritten to collect sensor information from the blade servers #1 to #3 in a round-robin manner. The management card 1A uses the blade number table 23 that is in the state of a table 2307 to collect the last sensor information from the blade server #1 (step S352). The management card 1A registers information indicating that production information collection is in progress on the column of the blade server #1 in the information collection state table 22. Accordingly, in the information collection state table 22, as illustrated in a table 2205, data on the column of the blade server #1 is set to 2 (two). In addition, the blade number table 23 is rewritten, as illustrated in a table 2308, so as to indicate the blade server #2 that is a next subject from which the operation information is to be acquired.

The management card 1A uses the blade number table 23 that is in the state of a table 2308 to collect the last sensor information from the blade server #2 (step S353). The management card 1A registers information indicating that the production information collection is in progress on the column of the blade server #2 in the information collection state table 22. Accordingly, in the information collection state table 22, as illustrated in a table 2206, data on each of the columns of the blade servers #1 and #2 is set to 2 (two). In addition, the blade number table 23 is rewritten, as illustrated in a table 2309, so as to indicate the blade server #3 that is a next subject from which the operation information is to be acquired.

The management card 1A uses the blade number table 23 that is in the state of a table 2309 to collect the last sensor information from the blade server #3 (step S354). The management card 1A registers information indicating that the production information collection is in progress on the column of the blade server #3 in the information collection state table 22. Accordingly, in the information collection state table 22, as illustrated in a table 2207, data on each of the columns of the blade servers #1 to #3 is set to 2 (two).

Thereafter, in the same manner as the case that the sensor information is collected, the management card 1A repeatedly rewrites the blade number table 23 in the order from #1 to #3, as illustrated in a table group 2310. The management card 1A uses the blade number table 23 that is repeatedly rewritten to collect, in the same manner as steps S355 to S357, production information from the blade servers #1 to #3 in a round-robin manner.

The management card 1A uses the blade number table 23 that is in the state of a table 2311 to collect the last production information from the blade server #1 (step S358). The management card 1A also registers information indicating that operation information collection is completed on the column of the blade server #1 in the information collection state table 22. Accordingly, in the information collection state table 22, as illustrated in a table 2208, data on the column of the blade server #1 is set to 0 (zero). The management card 1A also registers information that indicates start-up completion on the column of the blade server #1 in the blade management table 21. Accordingly, in the blade management table 21, as illustrated in a table 2105, data on the column of the blade server #1 is set to 0 (zero). In addition, the blade number table 23 is rewritten, as illustrated in a table 2312, so as to indicate the blade server #2 that is a next subject from which the operation information is to be acquired.

Next, the management card 1A uses the blade number table 23 that is in the state of a table 2312 to collect the last production information from the blade server #2 (step S359). The management card 1A registers information indicating that operation information collection is completed on the column of the blade server #2 in the information collection state table 22. Accordingly, in the information collection state table 22, as illustrated in a table 2209, data on each of the columns of the blade servers #1 and #2 is set to 0 (zero). The management card 1A also registers information that indicates start-up completion on the column of the blade server #2 in the blade management table 21. Accordingly, in the blade management table 21, as illustrated in a table 2106, data on each of the columns of the blade servers #1 and #2 is set to 0 (zero). In addition, the blade number table 23 is rewritten, as illustrated in a table 2313, so as to indicate the blade server #3 that is a next subject from which the operation information is to be acquired.

Next, the management card 1A uses the blade number table 23 that is in the state of a table 2313 to collect the last production information from the blade server #3 (step S360). The management card 1A registers information indicating that operation information collection is completed on the column of the blade server #3 in the information collection state table 22. Accordingly, in the information collection state table 22, as illustrated in a table 2210, data on each of the columns of the blade servers #1 to #3 is set to 0 (zero). The management card 1A also registers information that indicates start-up completion on the column of the blade server #3 in the blade management table 21. Accordingly, in the blade management table 21, as illustrated in a table 2107, data on each of the columns of the blade servers #1 to #3 is set to 0 (zero). In addition, the management card 1A registers information indicating that there exists no blade server 3 that is a subject from which operation information is to be collected; that is 0 (zero), in the blade number table 23 as illustrated in a table 2314.

The IPMC 10 explained heretofore also has a hardware configuration including a CPU and a cache. Here, the hardware configuration of the IPMC 10 is not illustrated in particular. The cache achieves the functions of the storage unit for reception 12 and the storage unit for transmission 13. The CPU reads the blade management table 21, the information collection state table 22, the blade number table 23, or the like that are stored in the memory 102 or the like illustrated in FIG. 2, and loads the tables on the cache. The memory 102 illustrated in FIG. 2 stores therein various kinds of programs such as a program for achieving the functions of the information acquisition unit 11, the start-up processing unit 14, the blade server management units 31 to 33, or the like that are exemplified in conjunction with FIG. 4. The CPU of the IPMC 10 reads and executes various kinds of programs stored in the memory 102 thus achieving the functions such as the information acquisition unit 11, the start-up processing unit 14, the blade server management units 31 to 33, or the like that are exemplified in conjunction with FIG. 4.

As explained heretofore, in the management control device according to the present embodiment, state-transition information processing is performed in priority to the acquisition of operation information, and the acquisition of the operation information is performed in a round-robin manner. In this manner, the state-transition information processing is performed on a priority basis thus suppressing the delay of the state transition when a blade server is started up. Accordingly, it is possible to reduce the occurrence of timeout due to the delay of the state transition when the blade server is started up thus suppressing the interruption of a start-up sequence. The operation information is acquired in a round-robin manner thus suppressing the variation in start-up time of each blade server.

Here, in the present embodiment, in order to achieve more stable start-up timing of each blade server, the following two processes are performed; that is, the process such that state-transition information processing is performed in priority to the acquisition of operation information, and the process such that operation information is acquired in a round-robin manner. However, it is possible to acquire the advantageous effect that suppresses only the delay of the state transition of a blade server even when the management control device adopts the constitution that performs only the state-transition information processing in priority to the acquisition of operation information.

According to one aspect of an embodiment, the following advantageous effect is achieved; that is, the delay of the state transition in a start-up operation of an information processing device can be suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A management control device comprising:
an information acquisition unit that acquires state-transition information transmitted from each of a plurality of information processing devices started up, depending on state transition of each information processing device, the state-transition information indicating a current activation state of the information processing device; and
a controller that transmits, based on the acquisition of the state-transition information from a specific information processing device out of the information processing devices, an instruction of transition to a next state with respect to the specific information processing device in priority to an instruction other than the instruction of transition with respect to an information processing device other than the specific information processing device out of the information processing devices.

2. The management control device according to claim 1, wherein
the information acquisition unit acquires operation information used in operation of the information processing devices in addition to the state-transition information, and
the controller performs processing that requests at least the operation information as an instruction other than the instruction of transition.

3. The management control device according to claim 1, further comprising:
a storage unit that stores the state-transition information acquired by the information acquisition unit in a first storage unit, and stores information transmitted from the information processing device other than the state-transition information in a second storage unit, wherein
the controller performs the acquisition of the state-transition information from the first storage unit in priority to acquisition of information other than the state-transition information from the second storage unit, and transmits the instruction of transition to the next state corresponding to the state-transition information acquired to the information processing device that transmits the acquired state-transition information.

4. The management control device according to claim 1, wherein
the information acquisition unit acquires the state-transition information that indicates a first state in which the information processing device is ready for initiating a start-up operation, a second state in which the information processing device is ready for changing to an operation state that is a state to provide services, or a third state that is an operation state, and
the controller notifies the information processing device that is a source of the state-transition information indicating the first state of a start-up permission instruction to instruct transition to the second state, and notifies the information processing device that is a source of the state-transition information indicating the second state of an operation permission instruction to instruct transition to a third state.

5. The management control device according to claim 4, wherein the controller instructs the information processing device that is a source of the state-transition information indicating the third state to transmit the operation information.

6. The management control device according to claim 4, wherein the controller repeatedly acquires, when receiving the state-transition information that indicates the third state from the information processing devices, pieces of the operation information of the information processing devices one by one in a predetermined order.

7. The management control device according to claim 6, further comprising:
an instruction storage unit that stores therein an instruction of transmitting the operation information to each information processing device, the instruction storage unit being provided to each information processing device, wherein
the controller transmits the instructions stored in the instruction storage units one by one to the corresponding information processing device thus acquiring the operation information sequentially.

8. The management control device according to claim 6, wherein the controller once acquires the operation information from one of the information processing devices thus acquiring one type of operation information out of a plurality of types of the operation information.

9. An information processing system comprising:
a plurality of information processing devices; and
a management control device
each of the information processing devices including
an activation state notification unit that transmits state-transition information indicating a current activation state of the information processing device to the management control device depending on state transition of the information processing device in start-up operation; and
the management control device including
an information acquisition unit that acquires the state-transition information transmitted from each of the information processing devices started up, and
a controller that transmits, based on the acquisition of the state-transition information from a specific information processing device out of the information processing devices, an instruction of transition to a next state with respect to the specific information processing device in priority to an instruction other than the instruction of transition with respect to an information processing device other than the specific information processing device out of the information processing devices.

10. A method for management control, comprising:
acquiring state-transition information transmitted from each of a plurality of information processing devices started up, depending on state transition of the information processing device, the state-transition information indicating a current activation state of the information processing device; and
transmitting, based on the acquisition of the state-transition information from a specific information processing device out of the information processing devices, an instruction of transition to a next state with respect to the specific information processing device in priority to an instruction other than the instruction of transition with respect to an information processing device other than the specific information processing device out of the information processing devices.
